(19) United States
(12) Patent Application Publication
(10) Pub. No.: US 2023/0278312 A1
(43) Pub. Date: Sep. 7, 2023

(54) VEHICULAR INTERIOR COMPONENT

(71) Applicant: TOYOTA BOSHOKU KABUSHIKI KAISHA, Aichi-ken (JP)

(72) Inventors: Yuki IZAWA, Aichi-ken (JP); Kenji MIYAZAKI, Aichi-ken (JP)

(73) Assignee: TOYOTA BOSHOKU KABUSHIKI KAISHA, Aichi-ken (JP)

(21) Appl. No.: 18/112,627

(22) Filed: Feb. 22, 2023

(30) Foreign Application Priority Data
Mar. 1, 2022 (JP) 2022-030567

(51) Int. Cl. B32B 5/02; B60R 13/02; B32B 3/30

(52) U.S. Cl. CPC B32B 5/024; B60R 13/02; B32B 3/30; B60R 13/0243; B60R 13/0256; B32B 2262/0276; B32B 2262/0253; B32B 2262/0284; B32B 2262/0261; B32B 2262/023; B32B 2262/0246; B32B 2262/0238; B32B 27/32

(57) ABSTRACT

A vehicular interior component includes a base and a skin. The base includes a body portion, and a structural portion that includes one of a projection portion that projects toward a vehicular interior side than the body portion and a recessed portion that is recessed toward a vehicular exterior side than the body portion. The skin is disposed on a vehicular interior side of the base to cover at least the structural portion. The skin is a woven fabric that includes first threads extending in a first direction and second threads extending in a second direction that crosses the first direction and the first threads reflect light.

### CROSS REFERENCE TO RELATED APPLICATION

This application claims priority from Japanese Patent Application No. 2022-30567 filed on Mar. 1, 2022. The entire contents of the priority application are incorporated herein by reference.

### TECHNICAL FIELD

The present disclosure relates to a vehicular interior component.

### BACKGROUND

A vehicular interior component that includes a base having an interior side surface that is opposed to an interior space and a skin layer that is disposed on the interior side surface of the base has been known. The vehicular interior component has a shape that is recessed toward the interior space from a body panel side.

In such a vehicular interior component, with the interior side surface of the base being covered with the skin, the uneven shape of the base may not be clearly recognized depending on the thickness or material of the skin (the skin layer). This may deteriorate the design of the vehicular interior component. Light that passes through a window glass into the interior space of the vehicle may reflect off the skin toward the window glass. Such reflected light may cause the vehicular interior component to be reflected in the window glass

### SUMMARY

An object of the present technology is to provide a vehicular interior component that is improved in design. Another object of the present technology is to provide a vehicular interior component that is less likely to be reflected in a window glass.

A vehicular interior component according to the disclosure herein includes a base and a skin. The base includes a body portion, and a structural portion that includes one of a projection portion that projects toward a vehicular interior side than the body portion and a recessed portion that is recessed toward a vehicular exterior side than the body portion. The skin is disposed on a vehicular interior side of the base to cover at least the structural portion. The skin is a woven fabric that includes first threads extending in a first direction and second threads extending in a second direction that crosses the first direction and the first threads reflect light.

### BRIEF DESCRIPTION OF THE DRAWINGS

FIG. 1 is a cross-sectional view of a door trim according to a first embodiment.

FIG. 2 is a schematic view illustrating a portion of a vehicular interior seen from the left side.

FIG. 3 is an enlarged cross-sectional view of a portion of a skin.

FIG. 4 is a schematic view illustrating that light passes through a window glass.

FIG. 5 is a schematic view illustrating a portion of a vehicular interior seen from the left side.

### DETAILED DESCRIPTION

### First Embodiment

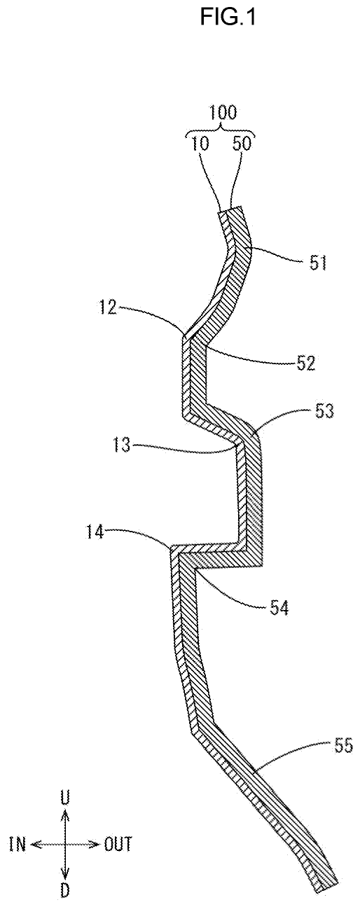

A first embodiment of the present technology will be described with reference to FIGS. 1 to 4. A door trim 100 (a vehicular interior component) that is mounted on a door panel included in a door of a vehicle 1 will be described. Arrows FR, RR, U, D, IN, and OUT represent a front side, a rear side, an upper side, a bottom side, a vehicular interior side, and a vehicular exterior side, respectively, in the drawings.

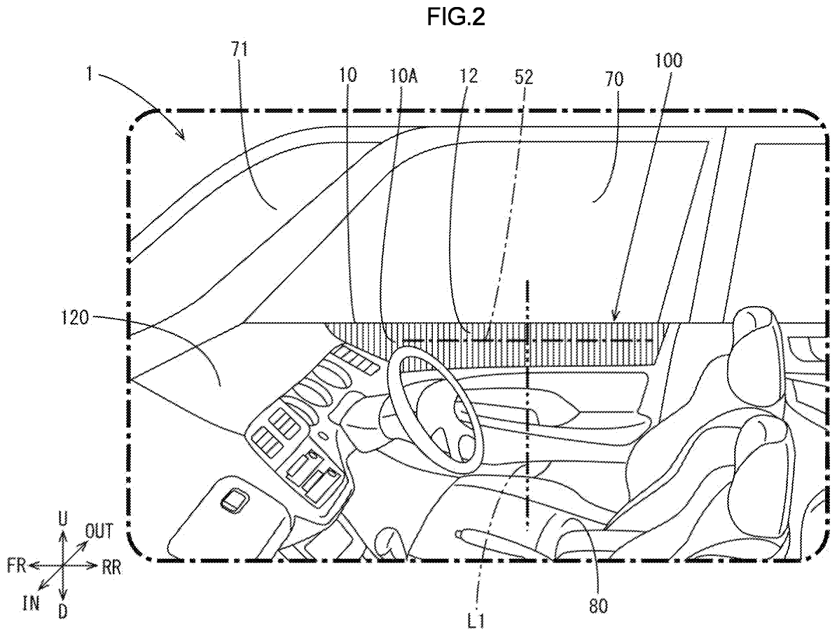

As illustrated in FIG. 1, the door trim 100 includes a base 50 that is a plate member and a skin 10. The skin 10 is a cloth that is thinner than the base 50. The skin 10 is bonded to a vehicular interior surface of the base 50 with adhesive. As illustrated in FIG. 2, the vehicle 1 includes the door trim 100, an instrument panel 120 that extends in a right-left direction (a vehicular width direction) in a front section of a vehicular interior, and window glasses 70, 71. The window glass 70 is a power window that can move up and down and is closest to the door trim 100 among the window glasses in the vehicle 1. The window glass 71 is a front glass through which an occupant sees the front and is closest to the instrument panel 120 among the window glasses in the vehicle 1.

As illustrated in FIG. 1, the base 50 includes body portions 51, 55, projection portions 52, 54 that project toward the vehicular interior side than the body portions 51, 55, and a recessed portion 53 that is between the projection portions 52, 54 and recessed toward the vehicular exterior side than the body portions 51, 55. The projection portions 52, 54 and the recessed portion 53 are examples of a structural component. Materials used for the base 50 is not particularly limited but may include synthetic resin such as polypropylene, ABS resin, polyurethane, and plant fibers bonded to each other with synthetic resin. An example of the plant fibers is kenaf fibers.

The body portion 51 is configured as an upper portion of the base 50 and is adjacent to the window glass 70 (refer to FIG. 2). The projection portion 52 is disposed below the body portion 51 and above the recessed portion 53. The projection portion 52 has a top that is a vehicular innermost portion and the top of the projection portion 52 is illustrated in FIG. 2 with a dashed line. The projection portion 52 extends in a front-rear direction (an extending direction). As illustrated in FIG. 1, the projection portion 54 is below the recessed portion 53 and is configured as an armrest on which a vehicular occupant can put on his or her arm.

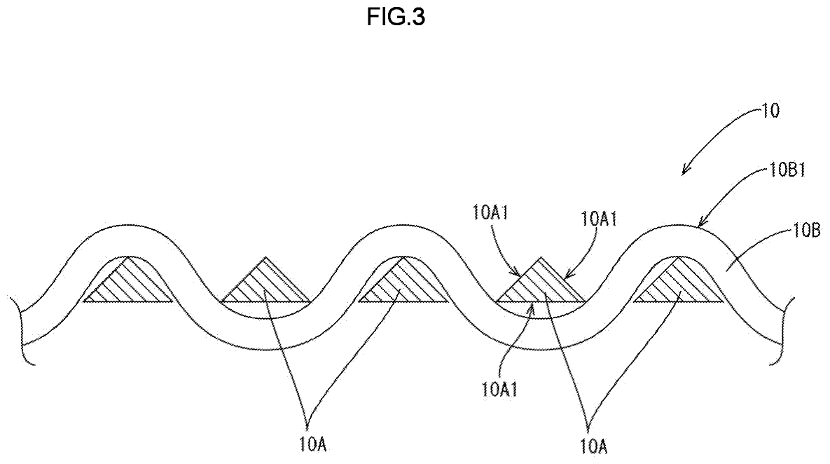

The skin 10 includes an upper skin portion 12 that covers the projection portion 52 from the vehicular interior side, a middle skin portion 13 that covers the recessed portion 53 from the vehicular interior side, and a lower skin portion 14 that covers the projection portion 54 from the vehicular interior side. As illustrated in FIG. 3, the skin 10 is a woven fabric made from warp threads 10A (first threads) and weft threads 10B (second threads). The warp threads 10A extend in an upper-bottom direction (a first direction) of the vehicular interior, and the weft threads 10B extend in a direction (a second direction) that crosses the direction in which the warp threads 10A extend. Namely, the weft threads 10B extend in a vehicular front-rear direction. The method of weaving with the warp threads 10A and the weft threads 10B is not particularly limited and may be plain weave, twill weave, and satin wave. A cross section of the warp threads 10A is illustrated in FIG. 3.

In FIG. 2, the warp threads 10A of the skin 10 are illustrated with stripes. The skin 10 is disposed on and covers the projection portion 52 such that the warp threads 10A extend in the direction that crosses the direction in which the projection portion 52 extends. Namely, the warp threads 10A extend in the upper-bottom direction (the first direction) that crosses the vehicular front-rear direction (the extending direction) in which the projection portion 52 extends. As illustrated in FIG. 2, the skin 10 is bonded to the base 50 such that the warp threads 10A extend along a line L1 that vertically connects a seat 80 installed in the vehicular interior and the window glass 70 that is adjacent to the door trim 100.

Materials used for the warp threads 10A and the weft threads 10B are not particularly limited and may be yarns formed by twisting synthetic fibers made of synthetic resin. Examples of the synthetic resin used for the synthetic fibers include polyester such as polyethylene, polypropylene, and polyethylene terephthalate, thermoplastic resin such as nylon, polystyrene, polycarbonate, methacrylic resin, polyvinyl chloride, and fluororesin, and thermosetting resin such as epoxy resin and silicon resin. One, two or more of the above synthetic resin may be used. Among the above synthetic resin, polyethylene terephthalate is preferably used. The material used for the warp threads 10A and the material used for the weft threads 10B may be same or different from each other.

The warp threads 10A reflect light. As illustrated in FIG. 3, the warp thread 10A includes three surfaces 10A1 and has a triangular cross section along a radial direction. The weft thread 10B has a circular cross section along a radial direction and has a curved surface 10B1. The surfaces 10A1 of the warp thread 10A are flat compared to the curved surface 10B1 of the weft thread 10B. The warp threads 10A are arranged such that the vertexes are at a surface of the skin 10. In FIG. 3, the warp threads 10A are arranged such that the vertexes face upward; however, the warp threads 10A may be arranged such that the vertexes face different directions.

The warp thread 10A includes fibers having a small diameter to increase a surface area of the warp thread 10A. This increases reflectivity of the warp thread 10A compared to that of the weft thread 10B. The diameter of the fibers used for the warp threads 10A is preferably 1 μm or more, more preferably 1.5 μm or more, much more preferably 2 μm or more, and preferably 10 μm or less, much more preferably 7 μm or less, much more preferably 5 μm or less. The diameter of the fibers used for the warp threads 10A may be any value that is in the range defined by one of the above lower values and one of the above upper values. The diameter of the fibers used for the weft threads 10B is preferably 6 μm or more, more preferably 8 μm or more, much more preferably 10 μm or more, and preferably 50 μm or less, much more preferably 40 μm or less, much more preferably 30 μm or less. The diameter of the fibers used for the weft threads 10B may be any value that is in the rage defined by one of the lower values and one of the upper values. In this embodiment, the diameter of the fibers used for the warp threads 10A is smaller than the diameter of the fibers used for the weft threads 10B. The reflectivity of the skin 10 as a whole is preferably 80% or higher and more preferably 85% or higher.

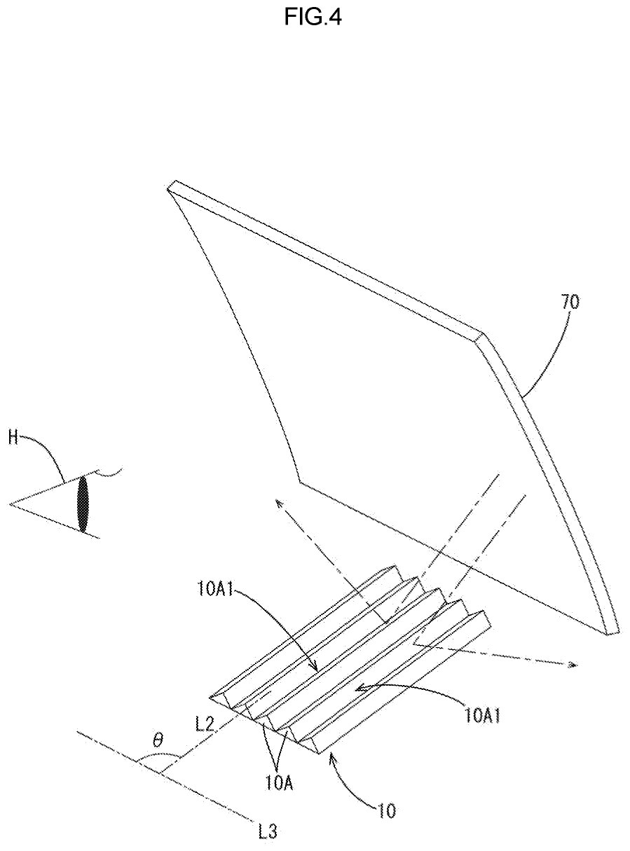

The weft threads 10B of the skin 10 are not illustrated in FIG. 4 to simply describe the arrangement and functions of the warp threads 10A. In FIG. 4, a line extending along the direction in which the warp threads 10A extend is defined as a line L2 and a line extending parallel to an edge of the window glass 70, which is arranged adjacent to the door trim 100, or extending along the vehicular front-rear direction is defined as a line L3. As illustrated in FIG. 4, the skin 10 is arranged such that the line L2 crosses the line L3 at an angle θ. The angle θ is greater than 0 degree and smaller than 180 degrees. Specifically, the angle θ is preferably 60 degrees or more, more preferably 75 degrees or more, and most preferably 90 degrees. The angle θ is preferably between 60 degrees and 90 degrees, inclusive. With the angle θ being defined as described above, the light passing through the window glass 70, which is illustrated with a dashed arrow in FIG. 4, hits the surfaces 10A1 of the warp threads 10A and is likely to be reflected in the vehicular front-rear direction. Accordingly, the light passing through the window glass 70 is less likely to reflect off the surfaces 10AI toward the window glass 70. Furthermore, the skin 10 is less likely to be reflected in the window glass 70. Even with the skin 10 being reflected in the window glass 70, the skin 10 reflected in the window glass 70 is less likely to be seen by a vehicular occupant. The angle θ is 90 degrees in this embodiment. In FIG. 4, the position relation of the window glass 70 and the skin 10 is schematically illustrated such that the orientations of the warp threads 10A with respect to the window glass 70 and the light passing through the window glass 70 and reflecting off the warp threads 10A can be easily described.

Next, effects of this embodiment will be described. The door trim 100 according to this embodiment includes the base 50 and the skin 10 that is disposed on a vehicular interior side surface of the base 50. The base 50 includes the body portions 51, 55, the projection portions 52, 54 that project toward the vehicular interior side than the body portions 51, 55, and the recessed portion 53 that is recessed toward the vehicular exterior side than the body portions 51, 55. The skin 10 is woven with the warp threads 10A extending in the first direction (the upper-bottom direction) and the weft threads 10B extending in the second direction (the vehicular front-rear direction) that crosses the first direction. The skin 10 covers the projection portions 52, 54 and the recessed portion 53 from the vehicular interior side. The warp threads 10A reflect light and have high reflectivity than the weft threads 10B.

According to the door trim 100, the skin 10 is woven with the warp threads 10A that reflect light and the weft threads 10B and has reflectivity. Such a skin 10 having reflectivity covers the projection portions 52, 54 from the vehicular interior side and the projection portions 52, 54 project toward the vehicular interior side than the body portions 51, 55. Therefore, light is likely to be supplied to the upper skin portion 12 and the lower skin portion 14 that are disposed on the projecting portions 52, 54 than the portions of the skin 10 disposed on the body portions 51, 55. Therefore, the skin portions 12, 14 on the projection portions 52, 54 can exert a glossy surface. The skin 10 covers the recessed portion 53 from the vehicular interior side and the recessed portion 53 is recessed toward the vehicular exterior side than the body portions 51, 55. Therefore, light is less likely to be supplied to the middle skin portion 13 that is disposed on the recessed portion 53 than the portions of the skin 10 disposed on the body portions 51, 55. Therefore, the middle skin portion 13 on the recessed portion 53 can exert a matte surface. Thus, the projection portions 52, 54 and the recessed portion 53 are likely to exert stereoscopic feeling and the skin 10 of the door trim 100 enhances the design shape of the base 50.

The projection portion 52 extends in the vehicular front-rear direction (the extending direction). The skin 10 is disposed to cover the projection portion 52 such that the direction (the upper-bottom direction, the first direction) in which the warp threads 10A extend crosses the front-rear direction in which the projection portion 52 extends. According to such a door trim 100, the light is reflected according to the shape of the projection portion 52. Stereoscopic feeling of the projection portion 52 is likely to be exerted and the design can be improved. In this embodiment, the extending direction in which the projection portion 52 extends is same as the direction in which the weft threads 10B extend.

The skin 10 is disposed on the vehicular interior side surface of the base 50 such that the warp threads 10A extend in the upper-bottom direction. According to such a door trim 100, the light passing through the window glass 70 into the vehicular interior space is likely to be reflected by the skin 10 in the vehicular front-rear direction and is less likely to be reflected by the skin 10 toward the window glass 70. Therefore, the door trim 100 is less likely to be reflected in the window glass 70.

The warp threads 10A have a triangular cross section. Accordingly, stereoscopic feeling of the projection portions 52, 54 and the recessed portion 53 are more likely to be exerted.

### Second Embodiment

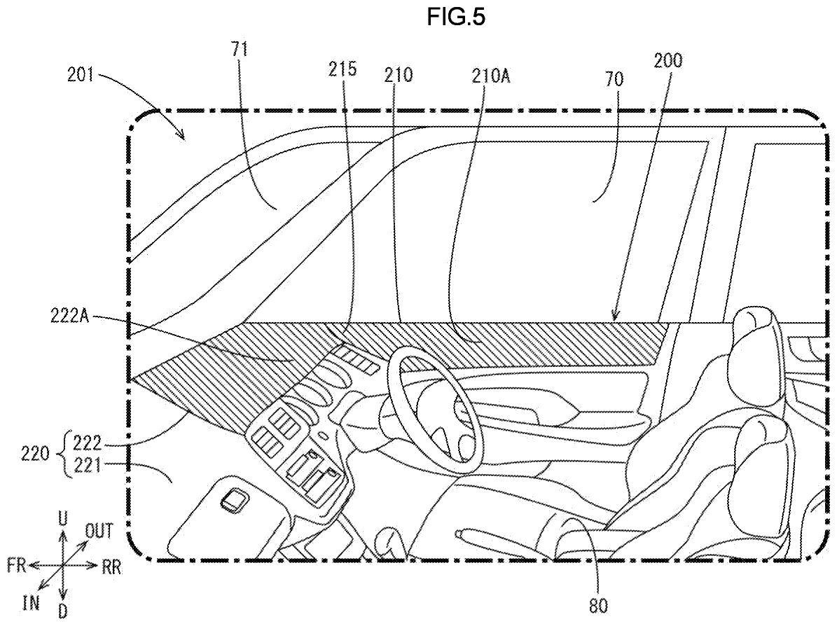

Next, a second embodiment will be described with reference to FIG. 5. The same symbols are used for the components of this embodiment that are same as those of the above embodiment and configurations, operations, and effects of the same components will not be described.

A vehicle 201 includes vehicular interior components such as a door trim 200 and an instrument panel 220 (another member). The instrument panel 220 includes a base 221 and a skin 222 (a first skin) that is attached to a vehicular interior side surface of the base 221. The skin 222 is a woven fabric made from warp threads 222A (third threads) and weft threads (fourth threads). The warp threads 222A and the weft threads of the skin 222 have configurations similar to those of the warp threads 10A and the weft threads 10B of the first embodiment, respectively. The warp threads 222A extend in a third direction and the weft threads extend in a fourth direction that crosses the third direction. The skin 222 is bonded to the base 221 such that the warp threads 222A extend obliquely with respect to edges of the base 221. Namely, the third direction in which the warp threads 222A extend crosses the vehicular width direction (a vehicular interior-exterior direction) and the vehicular front-rear direction.

The door trim 200 extends rearward from a side edge of the instrument panel 220. The door trim 200 includes the base 50 (refer to FIG. 1) and a skin 210 that is bonded to the vehicular interior side surface of the base 50. The skin 210 is a woven fabric made from warp threads 210A and weft threads that have configurations similar to those of the warp threads 10A and the weft threads 10B of the first embodiment, respectively. The warp threads 210A extend in an oblique direction (the first direction) that is oblique with respect to the vehicular front-rear direction and the upper-bottom direction. The weft threads of the skin 210 extend in a direction (the second direction) that crosses the oblique direction. The skin 210 is bonded to the base 50 such that the warp threads 210A extend obliquely with respect to an edge of the window glass 70.

The skin 210 includes a side edge skin portion 215 adjacent to the skin 222. The warp threads 210A (fifth threads) of the side edge skin portion 215 extend in a direction (a fifth direction) along the direction (the third direction) in which the warp threads 222A of the skin 222 extend. According to such a door trim 200, the side edge skin portion 215 and the skin 222 have similar light reflecting properties such as brightness and darkness of color. The direction (the fifth direction) in which the warp threads 210A of the side edge skin portion 215 extend is along the direction (the first direction) in which the warp threads 210A of the portions of the skin 210 other than the warp threads the side edge skin portion 215. Namely, the warp threads 210A of the skin 210 other than the warp threads 210A of the side edge skin portion 215 extend in the direction along the direction in which the warp threads 222A of the skin 222 extend in this embodiment. The warp threads 210A of the skin 210 including the side edge skin portion 215 extend in the same direction. However, the warp threads 210A of the side edge skin portion 215 extend along the direction in which the warp threads 222A extend and the warp threads 210A of the portions of the skin 210 besides the side edge skin portion 215 may not extend along the direction in which the warp threads 222A.

### OTHER EMBODIMENTS

The technology described herein is not limited to the embodiments described above with reference to the drawings. The technical scope of the present disclosure may include the following embodiments and all modifications in the scope of claim or its equivalent scope.

(1) The projection portion 52 extends in the front-rear direction in the first embodiment; however, the projection portion 54 and the recessed portion 53 may extend in the front-rear direction. The base may not have the shapes described in the above embodiments. The base may be configured to include only one of the projection portion and the recessed portion. The base may be divided into sections such as an upper board, a middle board below the upper board, and a lower board below the middle board. The upper board may include the projection portion projecting toward the vehicular interior side.

(2) The configurations of the warp threads 1A (first threads) and the weft threads 10B (second threads) may be altered as appropriate. For example, the warp threads 10A (the first threads) may have a rectangular cross section or a pentagonal cross section. The warp threads may have the configuration of the weft threads 10B and the weft threads may have the configuration of the warp threads 10A.

(3) The door trim is described in the above embodiments as the vehicular interior component; however, the vehicular interior component may be other interior components installed in the vehicular interior such as a pillar garnish and a console box.

(4) The vehicular interior component of the above embodiments may not be necessarily included in an automobile but may be included in various kinds of vehicles. Examples of the vehicles may be a train, an amusement vehicle, an autonomous vehicle, an airplane, a helicopter, a ship, and a submarine.

1. A vehicular interior component comprising:
a base including a body portion, and a structural portion that includes one of a projection portion that projects toward a vehicular interior side than the body portion and a recessed portion that is recessed toward a vehicular exterior side than the body portion; and
a skin disposed on a vehicular interior side of the base to cover at least the structural portion, the skin is a woven fabric that includes first threads extending in a first direction and second threads extending in a second direction that crosses the first direction, the first threads reflecting light.

2. The vehicular interior component according to claim 1, wherein
the structural portion extends in an extending direction, and
the skin is disposed to cover the structural portion such that the first direction crosses the extending direction.

3. The vehicular interior component according to claim 1, wherein the skin is disposed on the vehicular interior side of the base such that the first direction in which the first threads extend is along a vehicular upper-bottom direction or a vehicular interior-exterior direction.

4. The vehicular interior component according to claim 1, wherein
the skin includes an edge skin portion that is adjacent to a first skin on a vehicular interior side surface of another component,
the first skin is a woven fabric that includes third threads extending in a third direction and reflecting light and fourth threads extending in a fourth direction that crosses the third direction,
the edge skin portion includes fifth threads extending in a fifth direction and reflecting light and sixth threads extending in a sixth direction that crosses the fifth direction, and
the fifth direction in which the fifth threads extend in the edge portion is along the third direction in which the third threads extend.

5. The vehicular interior component according to claim 1, wherein the first threads have a triangular cross section.

6. The vehicular interior component according to claim 2, wherein the second direction is along the extending direction.

7. The vehicular interior component according to claim 1, wherein light reflectivity of the first threads is higher than light reflectivity of the second threads.

8. The vehicular interior component according to claim 1, wherein
the first threads include first fibers having a first diameter,
the second threads include second fibers having a second diameter, and
the first diameter is smaller than the second diameter.

9. The vehicular interior component according to claim 1, wherein the first diameter is from 1 μm to 5 μm, inclusive, and the second diameter is from 6 μm to 30 μm, inclusive.

10. The vehicular interior component according to claim 4, wherein the fifth direction is along the first direction.

11. The vehicular interior component according to claim 1, wherein
the skin is disposed on the base such that an angle between an edge of a window glass that is adjacent to the skin and the first direction in which the first threads extend is 60 degrees or greater and less than 180 degrees, the edge of the window glass extending in the second direction.

12. The vehicular interior component according to claim 11, wherein the angle is from 60 degrees to 90 degrees, inclusive.
